(19) United States
(12) Patent Application Publication
(10) Pub. No.: US 2001/0007739 A1
(43) Pub. Date: Jul. 12, 2001

(54) Lighting fixture for a medical or dental handpiece

(76) Inventors: Eugen Eibofner, Biberach (DE); Bernhard Lingenhole, Warthausen (DE); Walter Herzhauser, Biberach-Rissegg (DE)

Correspondence Address: Scully, Scott, Murphy & Presser, 400 Garden City Plaza, Garden City, NY, 11530, US

(21) Appl. No.: 09/733,326

(22) Filed: Dec. 8, 2000

(30) Foreign Application Priority Data
Dec. 29, 1999 (DE) 199 63 706 .7

(51) Int. Cl. A61C 1/08; A61C 3/00

(52) U.S. Cl. 433/29; 433/126

(57) ABSTRACT

The invention relates to a lighting fixture (18) for a medical or dental handpiece (2), having a lamp which forms with a base (17) a prefabricated constructional unit, the lamp having two conductor wires (34) which are located on two opposing outer sides of the base (17), wherein the lamp is formed by a light-emitting diode (16; 16b). The invention further relates to such a lighting fixture (18) in which the base (17) has a locking device (51) and the light-emitting diode (16b) is held on the base (17) by the locking device (51). Moreover, the invention relates to a method for manufacturing and assembling a lighting fixture for a medical or dental handpiece (29) having a base (17) and a lamp inserted therein.

The invention relates to a lighting fixture according to the preamble of claim 1 or 11.

A lighting fixture of this type is described in DE 42 16 873 A. This known lighting fixture is formed by a prefabricated constructional unit, comprising an incandescent lamp and a base, which has a receiving sleeve for the glass bodies of the lamp and a profiled plug-in pin, on the outsides of which two contact wires are arranged opposite each other in a respective longitudinal groove in the plug-in pin, the contact wires resting on the base surfaces of the longitudinal grooves. For the holding and contacting of the lighting fixture, there are provided on the handpiece, in a manner such that they are arranged opposite each other and extend substantially axially, two spring arms which grip in the longitudinal grooves of the plug-in pin, are prestressed against the base surfaces of the longitudinal grooves and thus also against the contact wires, and as a result form for the lighting fixture a holding device which is elastically flexible or floating in a manner predetermined by its elasticity and in which the lighting fixture is received in a vibration-damped manner. As a result of this floating holding device, the resistance wires of the lamp are protected from vibrations caused during the operation of the handpiece, for example as a result of a motor operation or as a result of the rotation of a drive shaft. Because the glass body of the lamp has a considerable length, and a radial support of the glass body in its front region is additionally required, the glass body is enclosed by a sleeve, with further elastic damping elements which dampen radial vibrating movements of the glass body being provided in the sleeve.

This known development has proven to be a solution which functions well and has a long life; however, the known construction has multiple parts and a costly construction and is thus expensive to produce.

The underlying object of the invention is therefore to develop a lighting fixture of the type presented in the introduction, in such a way that whilst maintaining a long life, the expenditure on production and the costs of production can be reduced.

This object is achieved by the features of claim 1. Advantageous developments of the invention are described in the subclaims.

In the lighting fixture in accordance with the invention, the lamp is formed by a light-emitting diode. This results in many advantages. A fundamental advantage is that a light-emitting diode is less sensitive to vibrations, and for this reason failures of the lamp during operation that are caused by vibrations are avoided. In this connection, a floating holding of the lighting fixture can be dispensed with, as a result of which not only the construction of the lighting fixture but also the construction of the handpiece are simplified and stabilised. This affects not only the holding of the lighting fixture between spring arms which can be bent freely outwards, but also the front radial damping of the lamp body, in which case a damping sleeve, as required in the known development, can be omitted. The development in accordance with the invention thus also results in a small construction, something which is advantageous particularly for a dental handpiece, the overall size of which is limited taking into account the restricted volume relations in the mouth space of a patient.

The electrical conductor wires of the light-emitting diode can be used to axially secure the light-emitting diode in the base as a result of the fact that they are bent round towards the inside at the end face of the plug-in pin of the base and, as a result of this, grip behind the plug-in pin on the end face. In order to stabilise this form-locking holding, it is advantageous to bend round or turn down the conductor wires towards the inside by more than 90 [symbol] , namely into a hollow space present in the plug-in pin. In order to axially secure the light-emitting diode in the base, the body of the light-emitting diode, in particular a base body, can, if necessary, additionally be fastened, in particular glued, in the receiving sleeve of the base.

Further claims and the method claim 10 relate to adaptive measures which make it possible to develop the base and/or the light-emitting diode with or without a spacer ring, in such a way that they fit each other, without the base having to be machined down, something which would be difficult because of the small internal dimension.

Particularly for a final instance of use, it is advantageous to shorten the contact wires on a standard light-emitting diode and to lengthen the shortened ends again by means of suitable conductor wires, with the aid of conductor wires which are, for example, round in cross-section, in particular have a smaller cross-sectional size.

In order to match light-emitting diodes having comparatively small or reduced cross-sectional sizes to the receiving sleeve of a base, it is advantageous to provide the spacer ring between the body of the light-emitting diode and the receiving sleeve.

In order to axially secure a light-emitting diode on the base, it is advantageous, according to claim 11, to provide on the base a locking device having at least one locking nose which grips behind a locking edge on the light-emitting diode. A flange on the diode body can serve as the locking edge, the diode body being of a standard available construction. This development renders possible an easy-to-handle assembly and disassembly of the light-emitting diode.

In the following, the invention and further advantages which can be achieved by it are explained in greater detail with the aid of preferred developments and drawings, in which:

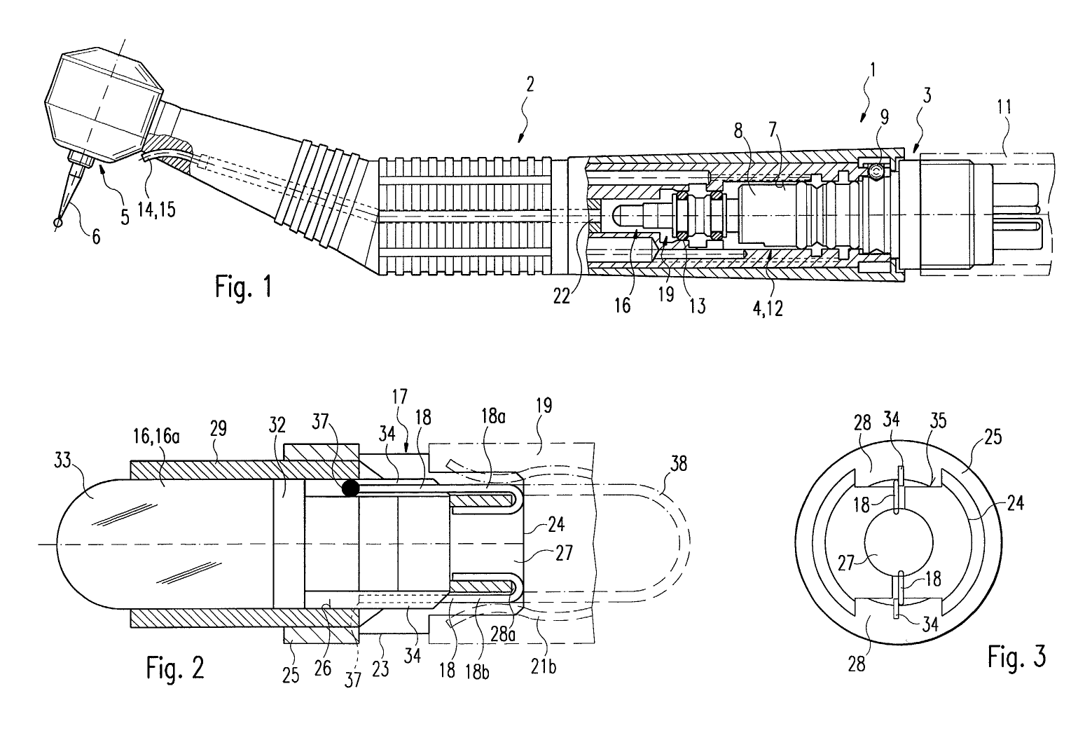

FIG. 1 shows a medical, in particular dental treatment instrument in accordance with the invention in side view;

FIG. 2 shows a lighting fixture of a lighting device for the treatment instrument as a separate constructional unit in axial section and in an enlarged representation;

FIG. 3 shows the lighting fixture in the front view from the right;

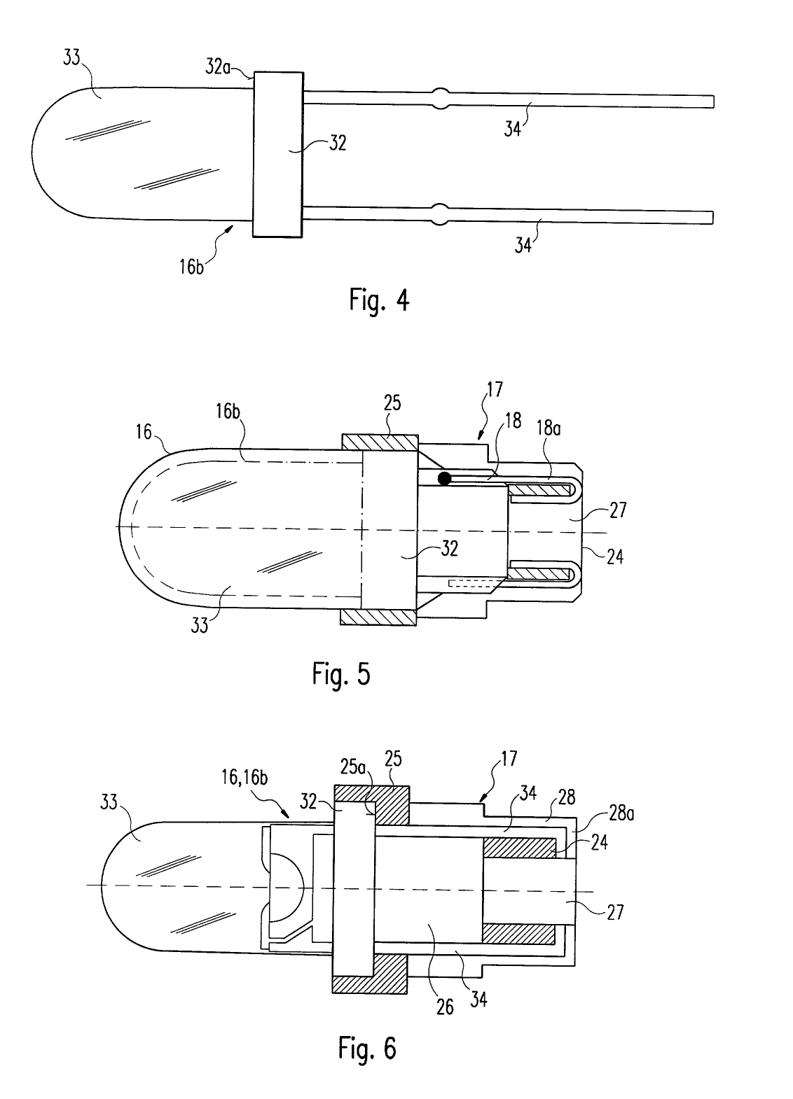

FIG. 4 shows a commercially available light-emitting diode in side view;

FIG. 5 shows a modified development of a lighting fixture in axial section;

FIG. 6 shows a further modified development of a lighting fixture in axial section;

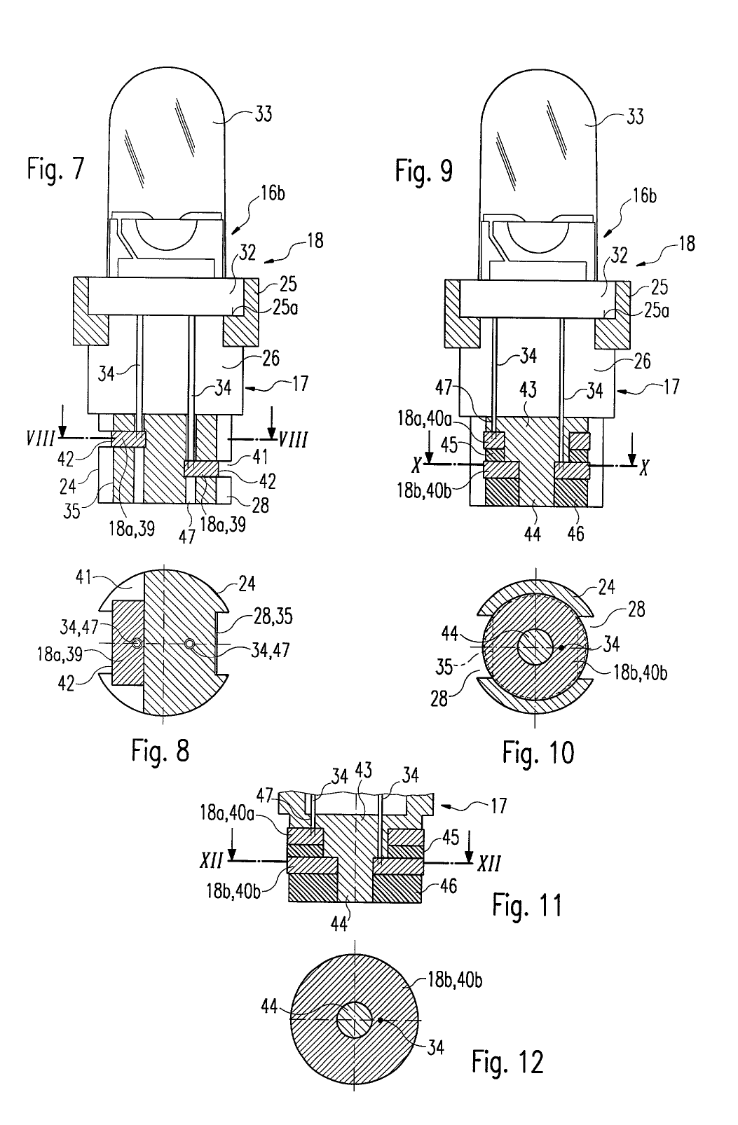

FIG. 7 shows a further modified development of a lighting fixture in axial section;

FIG. 8 shows the section VIII-VIII in FIG. 7;

FIG. 9 shows a further modified development of a lighting fixture in axial section;

FIG. 10 shows the section X-X in FIG. 9;

FIG. 11 shows a detail of a further modified development of a lighting fixture;

FIG. 12 shows the section XII-XII in FIG. 11;

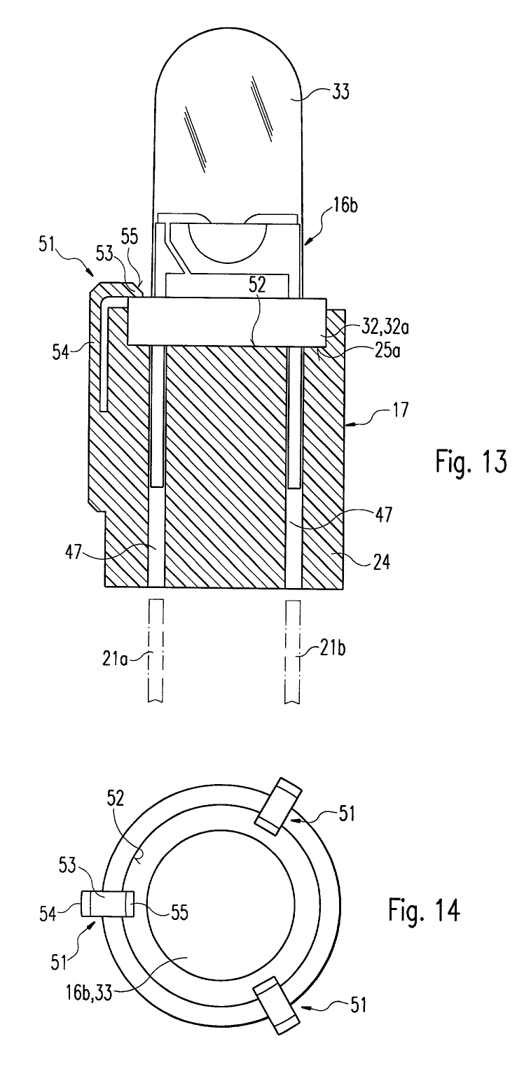

FIG. 13 shows a further modified development of a lighting fixture in axial section; and

FIG. 14 shows the lighting fixture according to FIG. 13 in plan view.

FIG. 1 shows a medical, in particular dental treatment instrument 1, which comprises a front instrument portion, namely a handpiece 2, and a rear instrument portion, namely a so-called connection piece 3, which are detachably connected to each other by a plug-in coupling 4, in particular a plug-in/rotating coupling. Arranged at the front end of the handpiece 2 is a holding device 5 or clamping device for a tool 6, the tool 6 being able to protrude to the side or to the front. On a rear end, the handpiece 2 has a coaxial coupling recess 7 into which a substantially cylindrical coupling pin 8 can be inserted and locked detachably by latching means 9 which are known per se. The coupling pin 8 projects from the connection portion 3, which is connected by a flexible supply line 11 to a control apparatus (not shown). The handpiece 2 is preferably mounted on the coupling pin 8 in a manner such that it can rotate freely, as a result of which the ease of operation of the instrument 1 is improved. Through this quick-action coupling, denoted generally with 12, extend one or more media lines for water, compressed air, spray and/or electric current, which lines extend axially or in a Z-shaped manner through the division joint of the plug-in/rotating coupling and are sealed in the region of the division joint 13 by means of sealing elements, such as sealing rings, for example.

Associated with the treatment instrument 1 is a lighting device, the whole of which is denoted with 14, having arranged in the front end region of the hand piece a light outlet opening 15 at which the light emerges, and illuminates a treatment site (not shown). An associated lamp 16a, formed by a light-emitting diode 16, can be arranged at the light outlet opening 15 or at a distance behind the latter and thus both on the handpiece 2 and on the connection portion 3. In the latter case, the light is passed on from the lamp 16a by a light guide, known per se, which extends up to the light outlet opening 15. The lamp 16a forms with a base 17 a constructional, which, with two contact elements 18a, 18b on the base 17, can be plugged into a plug-in socket 19 having appropriate counter-contact elements 21a, 21b. In the exemplary embodiment according to FIG. 1, the plug-in socket 19 is arranged on the front end of the coupling pin 8, in which case, in the mounted state, the light-emitting diode 16 radiates into the light guide 22 which is arranged coaxially with respect thereto.

The base 17 comprises a stepped-cylindrical base body 32, for example, which has a cylindrical plug-in pin 24 on its one end face and a hollow-cylindrical receiving sleeve 25 at its other end. The receiving space 26 surrounded by the receiving sleeve 25 extends in a manner such that it tapers in stages up to the plug-in pin 24, which has a coaxial recess 27 or bore on the inside and, on the outside, has two longitudinal grooves 28 which lie opposite each other, are rectangular in cross-section and can extend up to the receiving sleeve 25. A spacer sleeve 29, which projects over the receiving sleeve, preferably towards the front, is inserted into the receiving sleeve 25 and fastened therein, for example glued. Inserted into the spacer sleeve 29 is the light-emitting diode 16, which is of principally standard construction and has a cylindrical base body 32 from which extend, towards the front, a cylindrical luminous body 33 made of transparent material and, towards the rear, two conductor wires 34 made of metal which are at a lateral distance from each other, have a substantially square cross-sectional shape and can extend in the receiving space 26 substantially up to the plug-in pin 24. In the region of the longitudinal grooves 28 that lies between the plug-in pin 24 and the receiving sleeve 25, the receiving space 26 is through-connected to the longitudinal grooves 28, i.e. the flat base surface 35 is missing in this region and is present only in the region of the plug-in pin 24. The conductor wires 34 are extended by a respective contact wire 18, which is electrically conductively connected to the associated conductor wire 34, extends along the base surface 35 to the free end of the plug-in pin 24 and is bent round radially inwards, preferably in a U-shape, so that its free end region grips around the inside wall of the plug-in pin 24. In the present exemplary embodiment, the contact wires 18 and the conductor wires 34 overlap, the contact wires 18 resting in each case on the side face of the associated conductor wire 34 and, for example, being electrically conductively connected to the conductor wire 34 at their free ends, for example soldered or welded, preferably laser-welded. The fastening point is denoted with 37. The contact wires 36 can be arranged on one side of the conductor wires 34 or on opposing sides, as FIG. 3 shows.

In the exemplary embodiment according to FIG. 2, a base 17 and a light-emitting diode 16 which do not fit together are combined with each other. For this reason, at least the light-emitting diode 16 and, in the exemplary embodiment according to FIG. 2, also the base 17 are matched to each other according to a certain manufacturing process and mounted. Before a description of this manufacturing process, a commercially available probe 16b in accordance with FIG. 4 is described, which differs from the light-emitting diode 16 as a result of the fact that the base body 32 projects radially above the luminous body 33 with an annular shoulder 32a and the conductor wires 34 are longer, as evident from FIG. 4.

In order to adapt the commercially available light-emitting diode 16b, the following measures are carried out: namely first of all the conductor wires 34 are shortened by cutting them off to the above-described length, and the base body 32 is machined down, in particular turned, to a reduced diameter which can correspond to the diameter of the luminous body 33. Apart from this, the shortened conductor wires 34 are lengthened by the contact wires 36, which are preferably placed at the side of the conductor wires 34 and electrically connected thereto. In this connection, the conductor wires 36 can be formed by the free end regions of a common output wire 38 made of electrically conductive material, in particular copper, which has been bent into a U-shape. Because the output wire 38 is in one piece, the joining, positioning and fastening of the contact wires 36 at the conductor wires 34 is substantially simplified. After the fastening at the fastening points 37, the contact wires 36 are shortened to such a length that, in the mounted position, their free end regions protrude over the plug-in pin 24.

The light-emitting diode 16 which is prefabricated to this extent and the prefabricated spacer sleeve 29 are each mounted by plugging in, in which case first of all the spacer sleeve 29 can be plugged into the receiving sleeve 25, or first of all the light-emitting diode 16 can be plugged into the spacer sleeve 29. The free end regions of the contact wires 36 are then bent inwards around the free edge of the plug-in pin 24. As a result of this overlapping, the light-emitting diode 16 is secured against being axially pulled out of the spacer sleeve 29. In the opposite longitudinal direction, a positioning of the light-emitting diode 16 in the spacer sleeve 29 can take place as a result of the fact that the conductor wires 34 are axially delimited by the inside edge of the plug-in pin 24.

In the following, the method steps of a preferred manufacturing and assembly process are described.

The annular shoulder 32a is removed from the S light-emitting diode body, which preferably consists of transparent plastics, by turning.

The conductor wires 34 of the light-emitting diode 16b are shortened to a predetermined length, which is determined by the base 17 already used hitherto.

Extensions, here the contact wires 18, are electrically conductively attached to the conductor wires 34, preferably soldered thereto, which extensions are thinner than the conductor wires 34, with a common contact-wire section 38 which is bent into a U-shape preferably being used. Then, or in the meantime, the spacer sleeve 29 can be inserted into the base 17 and fastened, preferably by gluing.

Cutting to length of the contact wires 36, if a common contact wire 38 has been used.

The light-emitting diode 16 is plugged with the contact wires 36 into the spacer sleeve 29.

The contact wires 34 are bent round towards the inside, preferably into a position in which they grip behind the inside wall of the base 17, in which case they can be located in radial grooves 28a on the end face of the base 17.

The lighting fixture produced in this way fits into the known plug-in socket 19 described in the introduction, which renders possible a floating holding of the lighting fixture. The lighting fixture in accordance with the invention is thus compatible with the known lighting fixture having an incandescent lamp that was described in the introduction. In the context of the invention, however, it is also possible to provide for the lighting fixture a plug-in socket having a plug-in recess, to which the plug-in pin 24 is matched with little movement play and thus into which it can be plugged in a stabilised manner.

In the context of the invention, it is possible that instead of an adapting of the light-emitting diode 16b by machining, a light-emitting diode 16b is used, the cross-sectional size of which matches the internal cross-sectional size of the receiving sleeve 25 or the internal cross-sectional size of a spacer sleeve 29, the outer cross-sectional size of which is in turn matched to the internal cross-sectional size of the receiving sleeve 25.

In the arrangement in accordance with FIG. 5, the base body 32 is located fully in the receiving sleeve 25, with respect to the longitudinal direction.

In the exemplary embodiment according to FIG. 6, a commercially available light-emitting diode 16b is provided, the base body 32 of which is inserted into a receiving sleeve 25 having an internal shoulder surface 25a. Such an internal shoulder surface 25a can also be provided in the other developments of the lighting fixture or base 17.

In the exemplary embodiments according to FIGS. 7 to 12, in which parts which are the same are also provided with the same reference symbols, there is provided a plug-in pin 24 which does not have a recess 27. Apart from this, the conductor wires 34 of the light-emitting diode 16b are connected in each case to a contact segment 39, which is inserted into a transverse groove 41 extending transversely with respect to the longitudinal central axis of the plug-in pin 24, and the radial outer surface of which forms a contact surface 42 which is at the level of the base surface 35 or protrudes above the latter. The contact segments 39 can be arranged directly opposite each other or can be arranged such that they are axially offset with respect to each other, as FIG. 7 shows. The electrical contact takes place by means of the contact elements 21a, 21b, which can be constructed so as to be different lengths.

The exemplary embodiment according to FIGS. 9 and 10, in which parts which are the same or comparable are likewise provided with the same reference symbols, differs from the exemplary embodiment according to FIG. 7 as a result of the fact that the contact elements 18a, 18b are formed by contact rings 40a, 40b, which are arranged in a manner such that they are axially offset with respect to each other in the region of the plug-in pin 24, preferably on two cylindrical holding pegs 43, 44 of different sizes, on which the contact rings 40a, 40b sit and are fastened, for example by means of insulating or holding rings 45, 46, which are put on between them and in front of them and which can also sit on the holding pegs 43, 44 or even be preformed by injection moulding. Also in the exemplary embodiment according to FIG. 8, the longitudinal grooves 28 are provided, which ensure that the plug-in pin 24 is plugged in in a certain rotary position in each case, because the contact elements 21a, 21b immerse in the longitudinal grooves 28.

In the exemplary embodiment according to FIGS. 11 and 12, the contact elements 18a, 18b are likewise formed by contact segments 39 or by contact rings 40a, 40b, in which case, however, the longitudinal grooves 28 are missing and the counter-contact elements 21a, 21b are at a greater distance from each other and the contact elements 18a, 18b are arranged substantially on the surface line of the plug-in pin 24. In this development, the lighting fixture 18 can be inserted and contacted in each rotary position.

In the exemplary embodiments according to FIGS. 7 to 12, the conductor wires are possibly only shortened and not connected to further contact wires 36, in which case there are provided in the plug-in pin 24 suitable holes 47 for the conductor wires 34, which holes are parallel to the axis. In this connection, these can be through holes in the exemplary embodiment according to FIGS. 7 and 8, and blind holes in the exemplary embodiment according to FIGS. 9 to 12, which blind holes extend from the inside to the respective contact element 18a, 18b and can also be present in the respective contact element 18a, 18b for the purpose of connection to the contact elements 18a, 18b.

The above-described developments of the plug-in pins 24 and contact elements 18a, 18b can be combined with all other developments of the lighting fixture 18.

In the exemplary embodiment according to FIGS. 13 and 14, in which parts which are the same or comparable are provided with the same reference symbols, a light-emitting diode 16b is used which is a commercially available light-emitting diode, the conductor wires 34 of which can be shortened if appropriate, if the light-emitting diode 16b has not already been produced with appropriately short conductor wires 34. In this development, the light-emitting diode 16b is connected to the base 17 by a detachable locking device 51. In principle, the base 17 can be developed in accordance with the exemplary embodiment according to FIG. 11; however, the free space 26 between the plug-in pin 24 and the receiving sleeve 25 can be omitted, so that this base 17 can be constructed so as to be solid and the sleeve 25 and the stepped surface 25a are formed by a front-side recess 52 for the base body 32 of the light-emitting diode 16b.

Associated counter-contact elements 21a, 21b in the region of the plug-in pin 24 can, for example, be formed by preferably sleeve-shaped contact pins, as shown in outline in FIG. 13. The locking device 51 is formed by at least one locking nose 53, which protrudes from the base 17 towards the front and grips behind the base body 32 of the light-emitting diode 16b. The locking nose 53 is arranged on a connecting arm 54 which extends towards the front, and can be bent radially outwards against an elastic restoring force, which is generated by the inherent elasticity of the connecting arm 54. Furthermore, the locking nose 53 has a bevelled or rounded insertion surface 55, which effects an automatic yielding of the locking nose 53 when the base body 32 of the light-emitting diode 16b abuts against the insertion surface 55 when being mounted on the base 17. The locking device 51 can be released as a result of manual bending away of the locking nose 53. In order to increase the elasticity, the connecting arm 54 extends substantially parallel to the centre axis of the base 17 over approximately half the length thereof, forming an angular locking body with the locking nose 53.

For the purpose of increasing the stability, a plurality of locking devices 51 can be provided, for example three of them, which are distributed evenly over the circumference of the base, as FIG. 14 shows.

The base 17 and the spacer sleeve 29 preferably consist of plastics, being plastics injection-moulded parts.

1. Lighting fixture (18) for a medical or dental handpiece (2), having a lamp which forms with a base (17) a prefabricated constructional unit, the lamp having two conductor wires (34) which are located on two opposing outer sides of the base (17), characterised in that the lamp is formed by a light-emitting diode (16; 16b).

2. Lighting fixture according to claim 1, characterised in that in the region of the conductor wires (34), the base has longitudinal grooves (28) which lie opposite each other and on the base surfaces (35) of which the conductor wires (34) are located.

3. Lighting fixture according to claim 1, characterised in that the light-emitting diode (16; 16b) sits in a front-side recess (26; 52) of the base (17).

4. Lighting fixture according to claim 1, characterised in that the light-emitting diode is a commercially available light-emitting diode (16b) or a light-emitting diode (16) which has been adapted in terms of its cross-sectional size by machining.

5. Lighting fixture according to claim 1, characterised in that arranged between the light-emitting diode (16; 16b) and the base (17) is a spacer sleeve (29).

6. Lighting fixture according to claim 1, characterised in that the conductor wires (34) are shortened, and are lengthened by contact wires (18) electrically conductively connected to the shortened conductor wires (34).

7. Lighting fixture according to claim 1, characterised in that the conductor wires (34) or the contact wires (18) are bent round radially inwards at the rear end of the base (17).

8. Lighting fixture according to claim 7, characterised in that the conductor wires (34) or the contact wires (36) are bent round in a U-shape.

9. Lighting fixture according to claim 1, characterised in that it forms with the handpiece (2) and a connection portion (3) a treatment instrument, wherein the handpiece (2) has a coupling recess (7) which is round in cross-section, with which the handpiece (2) can be mounted on a coupling pin (8) which projects from the connection portion (3), wherein the coupling pin (8) has, on its front end, two counter-contact elements (21a, 21b) which are at a lateral distance from each other and between which the lighting fixture (18) is plugged in with its conductor wires (34), and wherein arranged in the handpiece (2) is a light guide (22) which extends from a position arranged in front of the light-emitting diode (16) to a light outlet opening (15) in the front region of the handpiece (2).

10. Method for manufacturing and assembling a lighting fixture for a medical or dental handpiece (2) having a base (17) and a lamp inserted therein, having the following method steps:
S use of a light-emitting diode (16b) and matching of the cross-sectional size thereof to the cross-sectional size of a recess of the base (17) by machining it down;
S shortening of the conductor wires (34) of the light-emitting diode (16b) to a length which is shorter than the length of the base (17);
S contact wires (36), which are so long that they protrude over the rear end of the base (17) in the mounted position, are electrically conductively connected to the conductor wires (34);
S insertion and fastening of a spacer sleeve (29) in the base (17);
S insertion of the light-emitting diode (16b) with the lengthened contact wires (38) into the spacer sleeve (29);
S bending round of the ends of the contact wires (36) radially inwards or into a U-shaped position in which they grip behind an inside wall of the base (17).

11. Lighting fixture (18) for a medical or dental handpiece (2), having a lamp which forms with a base (17) a prefabricated constructional unit, the lamp having two conductor wires (34), characterised in that the base (17) has a locking device (51) and the light-emitting diode (16b) is held on the base (17) by the locking device (51).

12. Lighting fixture according to claim 11, characterised in that the base (17) has, in its front end region, a recess (52), into which a base body (32) of the light-emitting diode (16b) is inserted, preferably from the front.

13. Lighting fixture according to claim 11, characterised in that the locking device (51) has at least one locking nose (53), which grips behind a locking edge, preferably arranged by an annular shoulder (32a) on the light-emitting diode, and can be moved transversely against an elastic restoring force into a release position.

14. Lighting fixture according to claim 13, characterised in that the locking nose (53) is arranged on a connecting arm (54) which extends substantially parallel to the axis and can be bent outwards elastically in a transverse direction.

15. Lighting fixture according to claim 11, characterised in that two or more, preferably three, locking devices (51) arranged opposite each other are provided.

16. Lighting fixture according to claim 11, characterised in that the light-emitting diode (16b) has two conductor wires (34) which are at a lateral distance from each other and which are received in a common recess or in holes (47) in the base (17), which holes are substantially parallel to the axis.
